(19) United States
(12) Patent Application Publication
(10) Pub. No.: US 2013/0154999 A1
(43) Pub. Date: Jun. 20, 2013

(54) Multi-Surface Touch Sensor Device With User Action Detection

(71) Applicant: David Brent GUARD, Southhampton (GB)

(72) Inventor: David Brent GUARD, Southhampton (GB)

(21) Appl. No.: 13/330,098

(22) Filed: Dec. 19, 2011

(51) Int. Cl. G06F 3/044

(52) U.S. Cl. 345/174

(57) ABSTRACT

In one embodiment, a method includes providing a device that includes at least one touch sensor. The device has a plurality of surfaces and edges. A plurality of touches at one or more of the surfaces or edges are detected. At least one of these touches is detected at a surface or edge that is distinct from a front surface of the device that overlays an electronic display of the device and includes a touch-sensitive area. A user action is identified based upon at least the plurality of touches at the one or more surfaces or edges of the device.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch sensitive display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example device with multiple touch-sensitive areas on multiple surfaces.

FIG. 3 illustrates an example method for determining a user action performed by a user of a device with multiple touch-sensitive areas on multiple surfaces.

FIG. 4 illustrates an example method for determining an intended mode of operation of a device with multiple touch-sensitive areas on multiple surfaces.

FIG. 5A illustrates an example hold position of a device with multiple touch-sensitive areas on multiple surfaces.

FIG. 5B illustrates another example hold position of a device with multiple touch-sensitive areas on multiple surfaces.

### DESCRIPTION OF EXAMPLE EMBODIMENTS

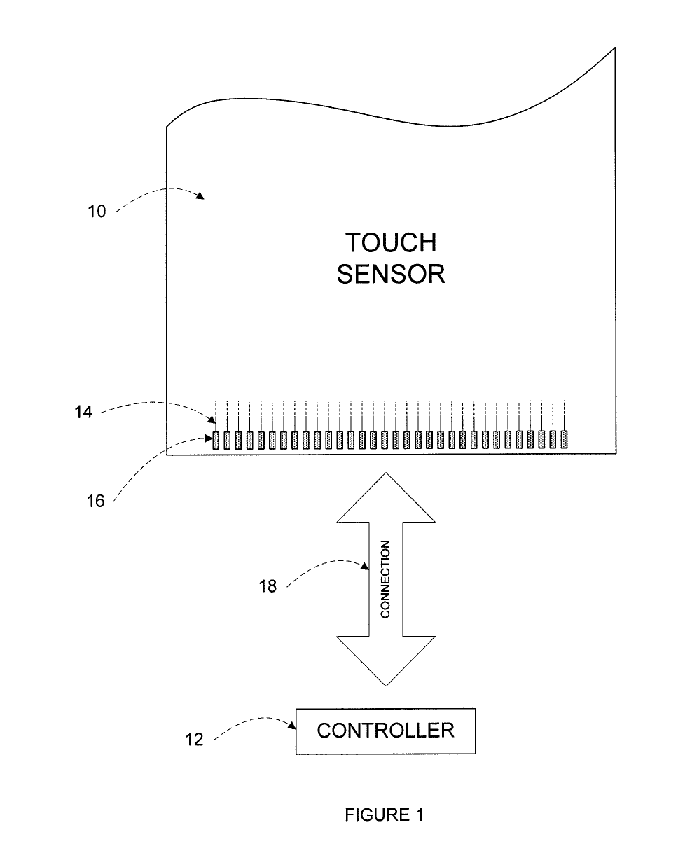

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape (sometimes referred to as 100% fill). As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness between approximately 1 μm and approximately 5 μm and a width between approximately 1 μm and approximately 10 μm. As another example, one or more portions of the conductive material may be silver or silver-based and similarly have a thickness between approximately 1 μm and approximately 5 μm and a width between approximately 1 μm and approximately 10 μm. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such as one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

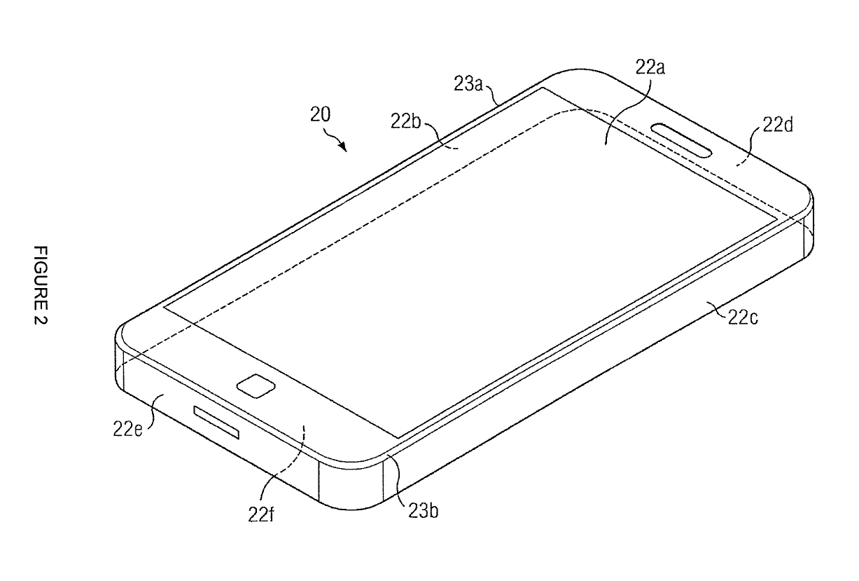

FIG. 2 illustrates an example device 20 with touch-sensitive areas on multiple surfaces 22. Examples of device 20 may include a smartphone, a PDA, a tablet computer, a laptop computer, a desktop computer, a kiosk computer, a satellite navigation device, a portable media player, a portable game console, a point-of-sale device, another suitable device, a suitable combination of two or more of these, or a suitable portion of one or more of these. Device 20 has multiple surfaces 22, such as front surface 22a, left-side surface 22b, right-side surface 22c, top surface 22d, bottom surface 22e, and back surface 22f. A surface 22 is joined to another surface at an edge 23 of the device. For example, adjoining surfaces 22a and 22b meet at edge 23a and adjoining surfaces 22a and 22c meet at edge 23b. Edges may have any suitable angle of deviation (e.g. the smaller angle of the two angles between respective planes that each include at least a substantial portion of one of the surfaces that are adjacent to the edge) and any suitable radius of curvature. In particular embodiments, edges 23 have an angle of deviation of substantially 90 degrees and a radius of curvature from about 1 mm to about 20 mm. Although this disclosure describes and illustrates a particular device with a particular number of particular surfaces with particular shapes and sizes, this disclosure contemplates any suitable device with any suitable number of any suitable surfaces with any suitable shapes (including but not limited to being planar in whole or in part, curved in whole or in part, flexible in whole or in part, or a suitable combination of these) and any suitable sizes.

Device 20 may have touch-sensitive areas on more than one of its surfaces 22. For example, device 20 may include one or more touch-sensitive areas on front surface 22a, left-side surface 22b, right-side surface 22c, top surface 22d, and bottom surface 22e. Each of the touch-sensitive areas detect the presence and location of a touch or proximity input on their respective surfaces. One or more of the touch-sensitive areas may each extend to near one or more of the edges of the respective surface 22 of the touch-sensitive area. As an example, a touch sensitive area on front surface 22a may extend substantially out to all four edges 23 of front surface 22a. The touch-sensitive areas may occupy any suitable portion of their respective surfaces 22, subject to limitations posed by the edges 23 of the surface and other surface features, such as mechanical buttons or electrical connector openings which may be on the surface. In particular embodiments, one or more edges 23 also include touch-sensitive areas that detect the presence and location of a touch or proximity input. A single touch sensor 10 may provide a single touch-sensitive area or multiple touch-sensitive areas.

One or more touch-sensitive areas may cover all or any suitable portion of their respective surfaces 22. In particular embodiments, one or more touch sensitive areas cover only a small portion of their respective surfaces 22. One or more touch-sensitive areas on one or more surfaces 22 may implement one or more discrete touch-sensitive buttons, sliders, or wheels. In various embodiments, a single touch sensor 10 includes multiple touch objects, such as X-Y matrix areas, buttons, sliders, wheels, or combinations thereof. For example, a touch sensor 10 may include an X-Y matrix area, with three buttons below the matrix area, and a slider below the buttons. Although this disclosure describes and illustrates a particular number of touch-sensitive areas with particular shapes and sizes on a particular number of particular surfaces of a particular device, this disclosure contemplates any suitable number of touch-sensitive areas of any suitable shapes, sizes, and input types (e.g. X-Y matrix, button, slider, or wheel) on any suitable number of any suitable surfaces of any suitable device.

One or more touch-sensitive areas may overlay one or more displays of device 20. The display may be a liquid crystal display (LCD), a light-emitting diode (LED) display, an LED-backlight LCD, or other suitable display and may be visible through the touch sensor 10 that provides the touch-sensitive area. Although this disclosure describes particular display types, this disclosure contemplates any suitable display types. In the embodiment illustrated, a primary display of device 20 is visible through front surface 22a. In various embodiments, device 20 includes one or more secondary displays that are visible through one or more different surfaces 22, such as back surface 22f.

Device 20 may include other components that facilitate the operation of the device such as a processor, memory, storage, and a communication interface. Although this disclosure describes a particular device 20 having a particular number of particular components in a particular arrangement, this disclosure contemplates any suitable device 20 having any suitable number of any suitable components in any suitable arrangement.

In particular embodiments, a processor includes hardware for executing instructions, such as those making up a computer program that may be stored in one or more computer-readable storage media. One or more computer programs may perform one or more steps of one or more methods described or illustrate herein or provide functionality described or illustrated herein. In various embodiments, to execute instructions, a processor retrieves (or fetches) the instructions from an internal register, an internal cache, memory, or storage; decodes and executes them; and then writes one or more results to an internal register, an internal cache, memory, or storage. Although this disclosure describes a particular processor, this disclosure contemplates any suitable processor.

One or more memories of device 20 may store instructions for a processor to execute or data for the processor to operate on. As an example and not by way of limitation, device 20 may load instructions from storage or another source to memory. The processor may then load the instructions from memory to an internal register or internal cache. To execute the instructions, the processor may retrieve the instructions from the internal register or internal cache and decode them. During or after execution of the instructions, the processor may write one or more results (which may be intermediate or final results) to the internal register or internal cache. The processor may then write one or more of those results to memory. In particular embodiments, the memory includes random access memory (RAM). This RAM may be volatile memory, where appropriate Where appropriate, this RAM may be dynamic RAM (DRAM) or static RAM (SRAM). This disclosure contemplates any suitable RAM. Although this disclosure describes particular memory, this disclosure contemplates any suitable memory.

Storage of device 20 may include mass storage for data or instructions. As an example and not by way of limitation, the storage may include flash memory or other suitable storage. The storage may include removable or non-removable (or fixed) media, where appropriate. In particular embodiments, the storage is non-volatile, solid-state memory. In particular embodiments, storage includes read-only memory (ROM). Although this disclosure describes particular storage, this disclosure contemplates any suitable storage.

A communication interface of device 20 may include hardware, software, or both providing one or more interfaces for communication (such as, for example, packet-based communication or radio wave communication) between device 20 and one or more networks. As an example and not by way of limitation, communication interface may include a wireless network interface card (WNIC) or wireless adapter for communicating with a wireless network, such as a WI-FI network or cellular network. Although this disclosure describes a particular communication interface, this disclosure contemplates any suitable communication interface.

In particular embodiments, device 20 includes one or more touch-sensitive areas on multiple surfaces 22 of the device, thereby providing enhanced user functionality as compared to typical devices that include touch-sensitive areas on only a single surface of a device. For example, in various embodiments, a user action (e.g. a gesture or particular manner of holding the device 20) is detected based on one or more touches at any of the surfaces of device 20. Such embodiments may allow for ergonomic use of device 20, since user actions may be performed on any surface or edge of the device, rather than the front surface only. An action may be performed based upon the detected user action. For example, device 20 may enter a new mode of operation in response to detecting touches corresponding to a particular manner of holding the device 20. Such embodiments may allow for relatively efficient and simple operation of device 20 since the need to navigate menus to access particular modes of operation is mitigated or eliminated.

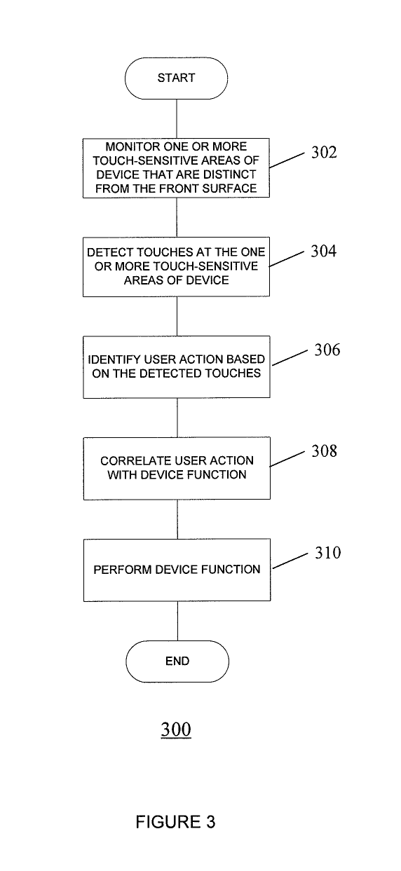

FIG. 3 illustrates an example method 300 for determining a user action performed by a user of device 20 with multiple touch-sensitive areas on multiple surfaces 22. At step 302, the method begins and one or more touch-sensitive areas of device 20 are monitored for touches. As an example, device 20 may monitor one or more of its surfaces 22 or edges 23 for touches. In particular embodiments, device 20 monitors at least one touch-sensitive area that is distinct from front surface 22a. At step 304, one or more touches are detected at one or more touch-sensitive areas of device 20. As an example, device 20 may detect one or more touches at one or more surfaces 22 or edges 23 of device 20. In particular embodiments, at least one of the detected touches occurs at a surface 22 or edge 23 that is distinct from front surface 22a.

At step 306, a user action is identified by device 20 based, at least in part, on one or more touches detected at the one or more touch sensitive areas of device 20. Device 20 is operable to detect a plurality of user actions by a user of device 20. Each user action corresponds to a particular method of interaction between a user and device 20. In particular embodiments, a user action is defined, at least in part, by one or more touches of one or more touch-sensitive areas of device 20 by a user. For example, characteristics of one or more touches that may be used to determine a user action include a duration of a touch, a location of a touch, a shape of a touch (i.e. a shape formed by a plurality of nodes at which the touch is sensed), a size of a touch (e.g. one or more dimensions of the touch or an area of the touch) a pattern of a gesture (e.g. the pattern made by a series of detected touches as an object is moved across a touch-sensitive area while maintaining contact with the touch-sensitive area), a pressure of a touch, a number of repeated touches at a particular location, other suitable characteristic of a touch, or any combination thereof. Examples of user actions include holding the device in a particular manner (i.e. a hold position), gestures such as scrolling (e.g. the user touches a touch-sensitive area of device with an object and performs a continuous touch in a particular direction) or zooming (e.g. a pinching motion with two fingers to zoom out or an expanding motion with two fingers to zoom in), clicking, other suitable method of interacting with device 20, or any combination thereof.

At least some of the user actions are defined, at least in part, by one or more touches at a touch-sensitive area that is distinct from front surface 22a. For example, a scrolling gesture may be defined by a scrolling motion made on right-side surface 22c or edge 23b. As another example, a hand position may be defined by a plurality of touches at particular locations on left-side surface 22b and right-side surface 22c. In typical devices, a front surface of a device may be the only surface of the device that is configured to detect touches corresponding to user actions. While front surface 22a may be suitable for receiving various user actions, it may be easier or more comfortable for a user to perform particular user actions on other surfaces 22 or edges 23 of the device 20. Accordingly, various embodiments of the present disclosure are operable to detect one or more touches at one or more touch-sensitive areas of device 20 that are distinct from surface 22a and to identify a corresponding user action based on the touches.

A user action may be identified in any suitable manner. In various embodiments, touch parameters are associated with user actions and used to facilitate identification of user actions. A touch parameter specifies one or more characteristics of a touch or group of touches that may be used (alone or in combination with other touch parameters) to identify a user action. For example, a touch parameter may specify a duration of a touch, a location of a touch, a shape of a touch, a size of a touch, a pattern of a gesture, a pressure of a touch, a number of touches, other suitable parameter associated with a touch, or a combination of the preceding. In various embodiments, a touch parameter specifies one or more ranges of values, such as a range of locations on a touch-sensitive area.

In particular embodiments, the touch parameters are dependent on the orientation of the device (e.g. portrait or landscape), the hand of the user that is holding the device (i.e. left hand or right hand), or the finger placement of the user holding the device (i.e. the hold position). For example, if the phone is held in a portrait orientation by a right hand, the touch parameters associated with an up or down scrolling user action may specify that a scrolling motion be received at right-side surface 22c, whereas if the phone is held in a landscape orientation by a left hand, the touch parameters associated with the up or down scrolling user action may specify that a scrolling motion be received at bottom surface 22e.

A particular user action may be identified by device 20 if the characteristics of the one or more touches detected by the device match the one or more touch parameters that are associated with the user action. Matching between a characteristic of a detected touch and a touch parameter associated with the user action may be determined in any suitable manner. For example, a characteristic may match a touch parameter if a value associated with the characteristic falls within a range of values specified by a touch parameter. As another example, a characteristic may match a touch parameter if a value of the characteristic deviates from the touch parameter by an amount that is less than a predetermined percentage or other specified amount. In particular embodiments, if a user action is associated with a plurality of touch parameters, a holistic score based on the similarities between the touch parameters and the corresponding values of characteristics of one or more detected touches is calculated. A match may be found if the holistic score is greater than a predetermined threshold or is a particular amount higher than the next highest holistic score calculated for a different user action. In various embodiments, no user action is identified if the highest holistic score associated with a user action is not above a predetermined value or is not a predetermined amount higher than the next highest holistic score calculated for a different user action.

A user action and its associated touch parameters may be specified in any suitable manner. As an example, one or more software application that are executed by device 20 may each include specifications of various user actions that may be detected while the software application is running. A software application may also include touch parameters associated with the user actions specified by the software application. In various embodiments, a user action applies to the operating system of the device 20 (that is, the user action may be detected at any time the operating system of the device 20 is running) or the user action is specific to a particular software application or group of software applications (and thus is only detectable while these applications are in use).

In a particular embodiment, device 20 is operable to receive and store user actions and associated touch parameters that are specified by a user of device 20. For example, a user of device 20 may explicitly define the touch parameters associated with a user action, or the user may perform the user action and the device 20 may determine the touch parameters of the user action based on one or more touches detected during performance of the user action. Device 20 may also store an indication received from the user of one or more applications that the user action applies to.

In particular embodiments, device 20 includes one or more sensors that provide information regarding motion or other characteristics of device 20. For example, device 20 may include one or more of: a uni- or multi-dimensional accelerometer, a gyroscope, or a magnetometer. As examples, a BOSCH BMA220 module or a KIONIX KTXF9 module may be included in device 20. The sensors may be configured to communicate information with touch-sensor controller 12 or a processor of device 20. As an example and not by way of limitation, a sensor may communicate information regarding motion in one or more dimensions. For example, the motion information may include acceleration measurements in the X, Y, and Z axes.

Data communicated by a sensor may be used in combination with one or more touches to identify a user action. For example, one or more accelerations or orientations of device 20 may be used in combination with one or more detected touches to identify a user action. As an example, a detection of multiple touches on multiple surfaces 22 of device 20 during periods of brief acceleration and deceleration of the device 20 followed by the removal of the touches and a period of no significant acceleration of the device 20 may correspond to the user action of a user putting device 20 in a pocket. As another example, a hold position of device 20 may be used in conjunction with an orientation measurement to determine the manner in which device 20 is being viewed.

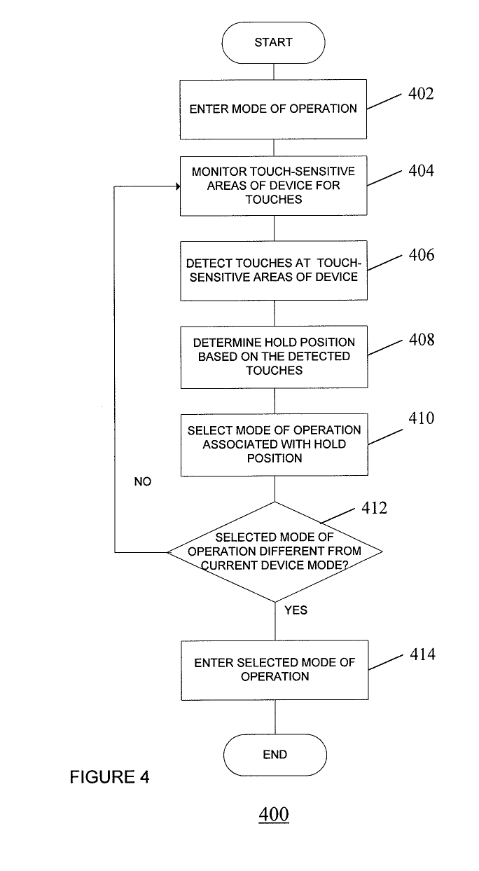

After a user action is identified, the user action is correlated with a device function of device 20 at step 308. A device function may include one or more actions performed by device 20 and may involve the execution of software code. As an example, as will be explained in more detail in connection with FIG. 4, a hold position (or other user action) may be correlated with a transition to a different mode of operation of device 20. As other examples, a scrolling user action may be correlated with a scrolling function that scrolls across an image displayed by device 20, a zooming user action may be correlated with a zooming function that enlarges or shrinks an image displayed by device 20, or a clicking user action may be correlated with the opening of a program or a link on a web browser of device 20. Any other suitable device function, such as the input of text or other data, may be correlated with a particular user action.

A user action may be correlated with a device function in any suitable manner. In particular embodiments, correlations between user actions and device functions are based on which software module is being run in the foreground of device 20 when the user action is detected. For example, one or more software modules may each have its own particular mapping of user actions to device functions. Accordingly, the same user action could be mapped to distinct device functions by two (or more) discrete software modules. For example, a sliding motion on a side of device 20 could be correlated with a volume change when device 20 is in a movie mode, but may be correlated with a zooming motion when the device is in a camera mode.

As part of the correlation between a particular user action and a device function, one or more processors of device 20 may detect the occurrence of the particular user action and identify executable code associated with the user action. In particular embodiments, user actions and indications of the correlated device functions (e.g. pointers to locations in software code that include the associated device functions) are stored in a table or other suitable format. At step 310, the device function correlated to the user action is performed by device 20 and the method ends. In various embodiments, one or more processors of device 20 executes software code to effectuate the device function.

The device function that is to be performed after a user action is detected may be specified in any suitable manner. In particular embodiments, the operating system of device 20 or software applications that run on device 20 may include specifications describing which device functions should be performed for particular user actions. Device 20 may be also be operable to receive and store associations between user actions and device functions specified by a user of device 20. As an example, a user may create a personalized user action and specify that the device 20 should enter a locked mode (or unlocked mode) upon detection of the personalized user action.

Particular embodiments may repeat the steps of the method of FIG. 3, where appropriate. Moreover, although this disclosure describes and illustrates particular steps of the method of FIG. 3 as occurring in a particular order, this disclosure contemplates any suitable steps of the method of FIG. 3 occurring in any suitable order. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

FIG. 4 illustrates an example method 400 for determining an intended mode of operation of device 20. At step 402, the method begins and device 20 enters a particular mode of operation. In particular embodiments, entering a mode of operation includes execution of software code by device 20 to display a particular interface to a user of device 20. In various embodiments, a mode of operation corresponds to a discrete software application or a portion of a software application that performs a particular function. For example, when device 20 enters a particular mode of operation, device 20 may activate a particular software application corresponding to the mode of operation (e.g. device 20 may open the application, display the application, or otherwise execute various commands associated with the application).

Device 20 may enter any suitable mode of operation. Examples of modes of operation include call, video, music, camera, self-portrait camera, movie, web browsing, game playing, locked, default, and display modes. A call mode may provide an interface for making a telephone or video call and in particular embodiments includes display of a plurality of numbers that may be used to enter a telephone number. A video mode may provide an interface for viewing videos and in particular embodiments includes a display of a video player or a list of video files that may be played. A music mode may provide an interface for listening to music and in particular embodiments includes a display of a music player or a list of music files that may be played. A camera mode may provide an interface for taking pictures and in particular embodiments includes display of an image captured through a lens of device 20 or otherwise configuring device 20 to take a picture (e.g. an image capture button may be displayed on a surface 22 or the device 20 may otherwise be configured to detect picture-taking user actions). A self-portrait camera mode may provide an interface similar to that described for the camera mode and in particular embodiments may include display of an image captured through a lens on the back surface 22f of device 20 (assuming a lens on the back surface is being used to take pictures) to aid users in taking pictures of themselves. In particular embodiments, a self-portrait camera mode may alternatively include activating a lens on the front surface 22a of device 20. A movie mode may provide an interface for recording movies with device 20 and in particular embodiments includes display of an image captured through a lens of device 20 or otherwise configures device 20 to take a movie (e.g. it may display a record button on a surface 22 of the device 20 or the device 20 may otherwise be configured to detect movie-making user actions). A web browsing mode may provide an interface for browsing the Internet and in particular embodiments includes display of a web browser. A game playing mode may provide an interface for playing games and in particular embodiments includes display of a particular game or a list of available games. A locked mode may include preventing access to one or more functions of device 20 until the device 20 is unlocked (e.g. an unlocking user action is performed). A default mode may provide a default view such as one or more menus or background pictures. In particular embodiments, device 20 enters the default mode after it is powered on or if no application is active (i.e. being displayed by device 20). A display mode may specify how graphics are displayed by device 20. In particular embodiments, one display mode may display graphics in a landscape view and another display mode may display graphics in a portrait view. In particular embodiments, a particular mode of operation may include a display mode and another mode of operation. For example, a particular mode of operation may be a video mode displayed in a landscape view.

At step 404, device 20 may monitor one or more touch-sensitive areas of device 20 for touches. In particular embodiments, device 20 monitors multiple surfaces 22 or edges 23 for touches. At step 406, one or more touches are detected at one or more of surfaces 22 or edges 23. In some embodiments, steps 404 and 406 of method 400 correspond respectively to steps 302 and 304 of method 300.

At step 408, a hold position is determined based on the detected touches. A hold position is an indication of how a user is holding the device 20. A hold position may be determined in any suitable manner, including using one or more of the techniques describe above in connection with identifying user actions in step 306 of method 300. As an example, each hold position may have one or more associated touch parameters that are compared against characteristics of one or more touches detected at step 406 to determine whether the one or more touches constitute the hold position.

A hold position is determined, at least in part, by detecting a plurality of touches on a plurality of surfaces 22 or edges 23 in the illustrated embodiment. For example, a hold position may be associated with touch parameters that each specify one or more touches at one or more particular locations on device 20. A location may be defined in any suitable manner. As examples, a location may be one or more entire surfaces 22 or edges 23, one or more particular portions of a surface 22 or edge 23, or one or more particular touch sensor nodes. In particular embodiments, a hold position is associated with touch parameters that specify a plurality of touches at positions relative to each other. For example, touch parameters of a hold position may specify two or more touches that are separated from each other by a particular distance or a particular direction. Thus, a particular hold position may be associated with a particular configuration of one or more hands holding device 20 rather than the exact locations of touches detected (although these locations may be used to determine that the device 20 is being held in the particular configuration). In particular embodiments, a hold position is determined by detecting that a plurality of touches at various locations of a plurality of surfaces 22 or edges 23 are occurring simultaneously. In various embodiments, the order in which the touches are detected are also used to determine a hold position.

In particular embodiments, a hold position is defined by a plurality of touch parameters that each specify a touch by a particular finger of a user. Each of these touch parameters, in various embodiments, also specify that the touch by the particular finger occur at a particular location of device 20. For example, a hold position may be defined, at least in part, by a touch by a thumb anywhere on left-side surface 22b and touches by an index finger, middle finger, and ring finger anywhere on right-side surface 22c. In some embodiments, the touch parameters specify touches by particular fingers in a particular configuration. For example, a particular hold position may be defined, at least in part, by an index finger, middle finger, and ring finger being placed adjacent to each other on a surface 22 or edge 23 of device 20.

In various embodiments, in order to determine whether a user is holding device 20 in a particular manner, a detected touch or a group of contiguous touches (i.e. touches at two or more adjacent sensor nodes) is associated with a particular finger of a user holding device 20. Any suitable method may be used to determine which finger to associate with a touch or group of touches. As an example, one or more dimensions of an area at which touches (e.g. contiguous touches) are detected may be used to determine which finger touched the area. For example, a relatively large area over which touches are detected may correspond to a thumb and a relatively small area may correspond to a pinky.

After a hold position is detected, a mode of operation associated with the hold position is selected at step 410. The mode of operation associated with the hold position may be selected in any suitable manner. For example, a memory of device 20 that stores associations between hold positions and device modes may be accessed to select the device mode. After selecting the mode of operation associated with the hold position, device 20 determines whether the current mode of operation of the device 20 is the same as the selected device mode at step 412. If the selected mode of operation is the same as the current device mode, then device 20 stays in the current mode of operation and resumes monitoring of the touch-sensitive areas of device 20 at step 404. If the selected mode of operation is different from the current device mode, device 20 enters the selected mode of operation at step 414. Entering the selected mode of operation may involve steps similar to those described above in connection with step 402.

In some embodiments, device 20 provides an indication of the selected mode of operation to a user of the device prior to entering the selected mode of operation. The indication may be provided in any suitable manner. For example, the indication may be displayed by device 20. As another example, the indication may be spoken by device 20. In particular embodiments, the indication is text describing the selected mode of operation. In other embodiments, the indication is a symbol, such as an icon, of the selected mode of operation. After the indication is provided, the user of the device 20 may choose whether the device will enter the selected mode of operation or not. For example, the user may perform a user action that indicates whether the device should enter the selected mode of operation. As another example, the user may indicate agreement or disagreement with the selected mode of operation through speech. After the device 20 receives the user's choice, it responds accordingly by either entering the selected mode of operation or remaining in its current mode of operation.

In particular embodiments, device 20 is operable to store hold positions specified by a user of device 20. Device 20 may also be operable to record associations between the hold positions and modes of operation specified by a user. As an example, a user may explicitly define the touch parameters associated with a new hold position. As another example, an application of device 20 may prompt a user to hold the device 20 in a particular manner. The device 20 may then sense touches associated with the hold position, derive touch parameters from the sensed touches, and associate the touch parameters with the new hold position. The user may then select a mode of operation from a plurality of available modes of operation and associate the selected mode of operation with the new hold position. As another example, if multiple touches are sensed at step 406, but the touches do not correspond to an existing hold position, device 20 may ask the user whether to record the new hold position and to associate the new hold position with a mode of operation.

Particular embodiments may repeat the steps of the method of FIG. 4, where appropriate. Moreover, although this disclosure describes and illustrates particular steps of the method of FIG. 4 as occurring in a particular order, this disclosure contemplates any suitable steps of the method of FIG. 4 occurring in any suitable order. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

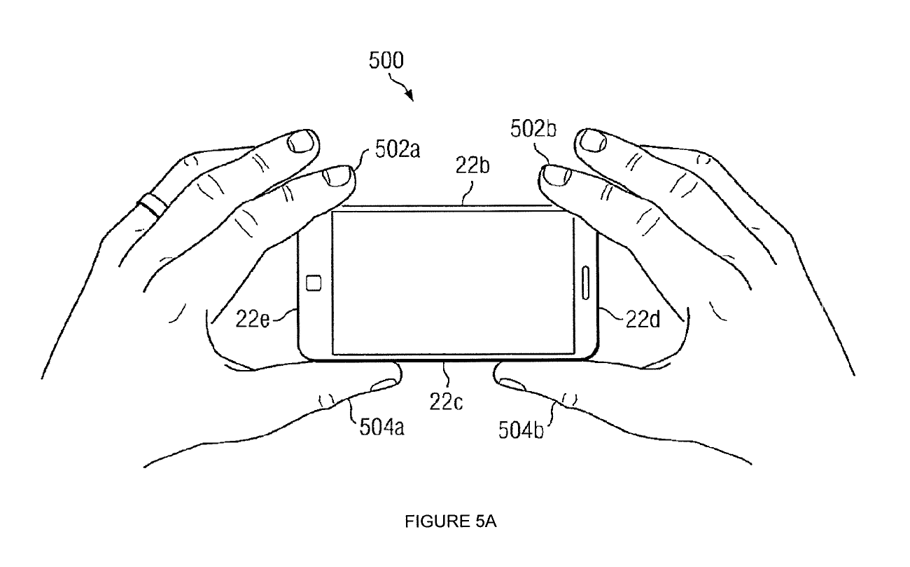

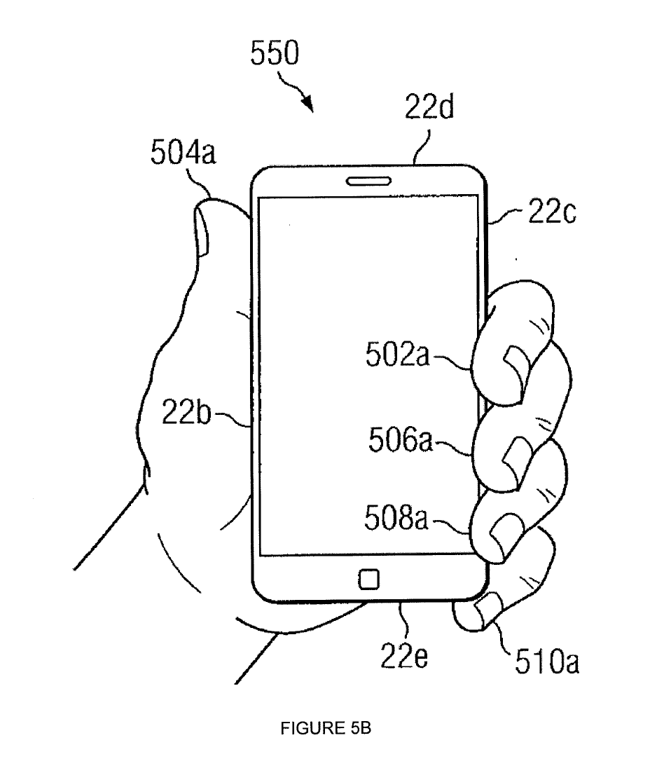

FIG. 5A illustrates an example hold position 500 of device 20. Hold position 500 may be associated with a camera mode of device 20. Accordingly, if hold position 500 is detected, device 20 may enter a camera mode. Hold position 500 may be associated with touch parameters that specify a touch on left-side surface 22b near bottom surface 22e, a touch on left-side surface 22b near top surface 22d, a touch on right-side surface 22c near bottom surface 22e, and a touch on right-side surface 22c near top surface 22d. Hold position 500 may alternatively be associated with touch parameters that specify two contiguous touches over small surface areas of left surface 22b (corresponding to touches by index fingers 502) and two contiguous touches on relatively larger surface areas of right-side surface 22c (corresponding to touches by thumbs 504).

FIG. 5B illustrates another example hold position 550 of device 20. Hold position 550 may be associated with a call mode of device 20. Accordingly, if hold position 550 is detected, device 20 may enter a call mode. Hold position 550 may be associated with touch parameters that specify a touch on left-side surface 22b near top surface 22d and three touches on right-side surface 22c distributed over the lower half of the right-side surface. Alternatively, hold position 550 may also be associated with touch parameters that specify contiguous touches on three small surface areas of right-side surface 22c (corresponding to touches by index finger 502a, middle finger 506a, and ring finger 508a) and a touch on a relatively larger surface area of left-side surface 22b (corresponding to a touch by thumb 504a). In particular embodiments, the call mode is also (or alternatively) associated with a hold position by a right hand that mirrors the depiction shown (where the thumb is placed on right-side surface 22c and three fingers are placed on left-side surface 22b).

In particular embodiments, data communicated by a sensor may be used in combination with a hold position to determine a mode of operation. For example, one or more accelerations or orientations of device 20 may be used in combination with a hold position to determine a mode of operation. As an example, an orientation of device 20 may be used with a detected hold position to determine an orientation mode of device 20. As another example, measurements from an accelerometer or a gyroscope may be used in combination with a detected hold position to determine that a user device 20 has picked up the device and intends to make a phone call. Accordingly, device 20 may enter a call mode to facilitate placement of the call. As yet another example, a detection of multiple touches on multiple surfaces 22 of device 20 during periods of brief acceleration and deceleration of the device 20 followed by the removal of the touches and a period of no significant acceleration of the device 20 may indicate that a user has put device 20 in a pocket. In particular embodiments, device 20 enters a locked mode upon such a determination.

Particular embodiments of the present disclosure may provide one or more or none of the following technical advantages. In particular embodiments, a multi-surface touch sensor system of a device may allow a user to perform a user action to effectuate a particular function of the device. Various embodiments may include detecting a user action based on one or more touches at a surface of a device that is distinct from the front surface of the device. Such embodiments may allow a user to perform various user actions in an ergonomic fashion. For example, a scrolling or zooming motion may be performed on a side surface of a device, rather than on the front surface of the device. As another example, a scrolling or zooming motion may be performed on an edge of the device, such as the edge between the front surface and the right-side surface or the edge between the front surface and the left-side surface. Particular embodiments may include detecting a hold position of the device and entering a particular mode of operation based on the detected hold position. Such embodiments may allow for quick and easy transitions between device modes and avoid or mitigate the use of mechanical buttons or complicated software menus to select particular device modes. Some embodiments may provide methods for customizing user actions (such as hand positions) and specifying functions to be performed when the customized user actions are detected.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
providing a device that includes at least one touch sensor, the device having a plurality of surfaces and a plurality of edges, each surface of the plurality of surfaces separated from at least one adjoining surface of the plurality of surfaces by a respective edge of the plurality of edges of the device, each edge of the plurality of edges comprising an angle of deviation between two surfaces of the plurality of surfaces of at least approximately 45°;
detecting at least one touch at one or more of the surfaces or edges of the plurality of surfaces and edges, one or more of the at least one touch detected at a surface or edge that is distinct from a front surface of the device, the front surface overlaying an electronic display of the device and comprising a touch-sensitive area implemented by the at least one touch sensor; and
identifying a particular user action based upon at least the at least one touch at the one or more surfaces or edges of the plurality of surfaces and edges.

2. The method of claim 1, further comprising entering the device into a particular mode of operation of a plurality of modes of operation of the device, each mode of operation of at least a subset of the plurality of modes of operation being associated with:
a distinct software module that indicates graphics displayed by the electronic display of the device while the device is in the respective mode of operation; and
one or more functions of the device that are each associated with a distinct user action.

3. The method of claim 2, further comprising:
correlating, by the device, the particular user action with a function of the device, the correlation determined using the particular mode of operation of the device and the identified user action; and
performing, by the device, the function of the device that is correlated with the particular user action.

4. The method of claim 1, wherein identifying the particular user action includes identifying a hold position that indicates the manner in which the device is being held by one or both hands of a user of the device.

5. The method of claim 4, the identifying the hold position comprising selecting the hold position from a plurality of hold positions, each hold position defined, at least in part, by a plurality of simultaneous touches at one or more surfaces of the device that are distinct from the front surface of the device.

6. The method of claim 1, the identifying the particular user action comprising associating at least one touch of the at least one touch with a particular finger of a user of the device.

7. The method of claim 1, the identifying the particular user action further comprising:
calculating a first location of the device based on a second location of a first touch of the at least one touch; and
determining whether a second touch of the at least one touch occurred at the first location of the device.

8. The method of claim 1, the particular user action comprising a scrolling or zooming motion performed on a surface of the device that adjoins the front surface, an edge of the front surface of the device, or an edge of the back surface of the device.

9. The method of claim 1, the identifying the particular user action further based on at least one sensor input from a sensor that is not a touch sensor.

10. The method of claim 9, the at least one sensor input comprising one or more of:
an acceleration measurement performed by an accelerometer of the device; and
an orientation of the device detected by a gyroscope of the device.

11. The method of claim 3, the performing the function of the device comprising unlocking the device.

12. One or more computer-readable non-transitory storage media embodying logic that is configured when executed to:
access a plurality of records that define a plurality of user actions that may be performed on a device, the device including at least one touch sensor, the device having a plurality of surfaces and a plurality of edges, each surface of the plurality of surfaces separated from at least one adjoining surface of the plurality of surfaces by a respective edge of the plurality of edges of the device, each edge of the plurality of edges comprising an angle of deviation between two surfaces of the plurality of surfaces of at least approximately 45°;
receive an indication of at least one touch at one or more of the surfaces or edges of the plurality of surfaces and edges, one or more of the at least one touch performed at a surface or edge that is distinct from a front surface of the device, the front surface overlaying an electronic display of the device and comprising a touch-sensitive area implemented by the at least one touch sensor; and
identify a particular user action from the plurality of user actions based upon at least the at least one touch at the one or more surfaces or edges of the plurality of surfaces and edges.

13. The media of claim 12, the logic further configured when executed to:
cause the device to enter into a particular mode of operation of a plurality of modes of operation of the device, each mode of operation of at least a subset of the plurality of modes of operation being associated with:
a distinct software module that indicates graphics displayed by the electronic display of the device while the device is in the respective mode of operation; and
one or more functions of the device that are each associated with a distinct user action.

14. The media of claim 13, the logic further configured when executed to:
correlate the particular user action with a function of the device, the correlation determined using the particular mode of operation of the device and the identified user action; and
cause the function of the device that is correlated with the particular user action to be performed.

15. The media of claim 12, wherein identifying the particular user action includes identifying a hold position that indicates the manner in which the device is being held by one or both hands of a user of the device.

16. The media of claim 15, the identifying the hold position comprising selecting the hold position from a plurality of hold positions, each hold position defined, at least in part, by a plurality of simultaneous touches at one or more surfaces of the device that are distinct from the front surface of the device.

17. The media of claim 12, the identifying the particular user action comprising associating one or more of the at least one touch with a particular finger of a user of the device.

18. The media of claim 12, the identifying the particular user action further based on at least one sensor input from a sensor that is not a touch sensor.

19. A device, comprising:
at least one touch sensor;
a plurality of surfaces and a plurality of edges, each surface of the plurality of surfaces separated from at least one adjoining surface of the plurality of surfaces by a respective edge of the plurality of edges of the device, each edge of the plurality of edges comprising an angle of deviation between two surfaces of the plurality of surfaces of at least approximately 45°;
an electronic display overlaid by a front surface of the plurality of surfaces, the front surface comprising a touch-sensitive area implemented by the at least one touch sensor;
a control unit coupled to the one or more touch sensors, the control unit operable to:
detect at least one touch at one or more of the surfaces or edges of the plurality of surfaces and edges, one or more of the at least one touch detected at a surface or edge that is distinct from the front surface of the device; and
identify a particular user action based upon at least the at least one touch at the one or more surfaces or edges of the plurality of surfaces and edges.

20. The device of claim 19, the control unit further operable to enter the device into a particular mode of operation of a plurality of modes of operation of the device, each mode of operation of at least a subset of the plurality of modes of operation being associated with:
a distinct software module that indicates graphics displayed by the electronic display of the device while the device is in the respective mode of operation; and
one or more functions of the device that are each associated with a distinct user action.

21. The device of claim 20, the control unit further operable to:
correlate the particular user action with a function of the device, the correlation determined using the particular mode of operation of the device and the identified user action; and
perform the function of the device that is correlated with the particular user action.

22. The device of claim 19, wherein identifying the user action includes identifying a hold position that indicates the manner in which the device is being held by one or both hands of a user of the device.

23. The device of claim 22, the identifying the hold position comprising selecting the hold position from a plurality of hold positions, each hold position defined, at least in part, by a plurality of simultaneous touches at one or more surfaces of the device that are distinct from the front surface of the device.

24. The device of claim 19, the identifying the particular user action comprising associating one or more of the at least one touch with a particular finger of a user of the device.

25. The device of claim 19, the identifying the particular user action further based on at least one sensor input from a sensor that is not a touch sensor.
